(19) United States
(12) Patent Application Publication
(10) Pub. No.: US 2012/0077541 A1
(43) Pub. Date: Mar. 29, 2012

(54) Mobile Phone Device Capable of Changing to Different Network Standards and Realizing Method

(76) Inventor: Wei Wu, Guangdong (CN)

(21) Appl. No.: 13/322,154

(22) PCT Filed: May 27, 2009
(86) PCT No.: PCT/CN09/72019

§ 371 Date: Nov. 22, 2011

(30) Foreign Application Priority Data
May 22, 2009 (CN) 200910039686.4

(51) Int. Cl. H04W 88/06

(52) U.S. Cl. 455/552.1

(57) ABSTRACT

A mobile phone device includes: a mobile phone body circuit board, which is provided with slots of a predetermined interface, and modular wireless processing modules with different network standards, which are provided with pins of the predetermined interface; when one network standard is used, the pins of the modular wireless processing module utilizing the network standard are plugged into the slots of the mobile phone body circuit board, and the communications between the circuit board and the modular wireless processing module are carried out by the predetermined interface; when the network standard is changed, the modular wireless processing module corresponding to other network standards is plugged instead into the slots of the predetermined interface in the mobile phone body circuit board. Users can change the different network standards, simply, easily and quickly, and the cost that manufacturers design mobile phones and users change networks is reduced.

### FIELD OF THE INVENTION

The invention relates to telecommunication filed and more particularly, relates to a mobile phone device capable of changing to different network standards and realizing method.

### BACKGROUND OF THE INVENTION

With the rapid development of communication technology, the size of mobile phone has become smaller and more popular than ever before. With the rapid development of mobile network, many kinds of telecommunication systems have emerged such as 2G network (GSM, Global System for Mobile Communications), CDMA (Code Division Multiple Access), CDMA2000 (Code Division Multiple Access 2000), CDMA20001X (Code Division Multiple Access 2000 1X), 3G WCDMA (3rd Generation Wideband Code Division Multiple Access), WCDMA HSPA (Wideband Code Division Multiple Access High-Speed Packet Access), CDMA1X EVDO (Code Division Multiple Access 2000 1X Evolution Data Optimization), CDMA1X EVDV (Code Division Multiple Access 2000 1X Evolution Data and Voice), TD-SCDMA (Time Division Synchronous Code Division Multiple Access), PHS (Payload Header Suppression), WiMax (Worldwide Interoperability for Microwave Access), and 4G LTE (4th Generation Long Term Evolution) in future. Many kinds of mobile phones are designed to maintain a closed construction, thus leading to compatibility of one type of phone with sole network standard. When a specific type of mobile phone is bought, the consumer is limited to use that type of network standard. To use different network standard, the consumer must get a mobile phone supporting that network standard, or the consumer must take two mobile phones, thereby resulting in inconvenience. Furthermore, the consumer should have to pay additional fees for different kind of mobile phone. For example, when the consumer desires to change network from CDMA to GSM, he must also change his mobile phone to support GSM network. Not only additional fees are to be paid for GSM type of mobile phone, but also the CDMA type of mobile phone may be discarded as electronic waste once it will be not used for any longer. Large amount of electronic waste will be generated in case mobile phone consumers all over the world discard their old mobile phones when changing network standard. This causes huge waste of global resources and brings bad effect to natural environment.

At present, mobile phone supporting two kinds of network standards has been developed in the field, such as Dual Model-dual standby mobile phone. The examples of this kind of phone may include C+G (CDMA+GSM), P+G (PHS+GSM), T+G (TDSCDMA+GSM), P+C (PHS+CDMA) and the like. This kind of mobile however, is expensive, large in size, short in standby time and only supports two specified network standards due to its close structure. Moreover, this kind of mobile phone fails to work in multiple network standards when roaming around the world. Take an example, network systems such as GSM, CDMA2000 1X, WCDMA, CDMA 1X, EVDO, TD-SCDMA or the like are popular in China, other network systems such as PHS, WCDMA, CDMA 1X, and EVDO are popular in Japan and Korea, some other systems including GSM, WCDMA, HSDPA are well known in Europe, while some other systems including CDMA 20001X, CDMA 1X EVDO, HSDPA and forthcoming 4G LTE are available in North America countries. With the increasing of global network systems, it will become hard for these dual model-dual standby mobile phones to support increased types of network systems or updated types of these network systems. As a result, some kinds of mobile phones made by different mobile phone manufacturers are only suitable to be sold in some particular countries. To be sold in other countries, the entire circuit board of the mobile phone must be redesigned completely, thus incurring large develop and design cost with which most manufacturers are burdened. This results in delay in emergence of new mobile phones in global market. In some bad case, newly developed mobile phones may not be present immediately in some countries due to above delay. Generally, research cost for a new mobile phone takes up 30-50% of the retail price. This means huge research cost must be paid by consumers, thus leading to high price of new mobile phone. A major reason for this is incompatibility of global network standards.

### SUMMARY OF THE INVENTION

One object of the present invention is to provide a mobile phone device capable of changing to different network standards and method for realizing the same. This enables the consumer to change among different network standards with simplicity, convenience and in a quick manner, hereby reducing design cost for manufacturers and cost of changing network standard for the consumers.

To realize the above object, there is provided a wireless terminal device capable of changing different network standards which includes a mobile phone body circuit board and a modular wireless processing module with different network standards. The modular wireless processing module is assembled together with an SIM (Subscriber Identity Module) card of the mobile phone. The mobile phone body circuit board is provided with slots of predetermined interface, while the modular wireless processing module with different network standards is provided with pins of the determined interface. When a specific network standard is employed, the pins of the modular wireless processing module supporting the specific network standard are inserted into corresponding slots of the mobile phone body circuit board. Communication is realized between the circuit board and modular wireless processing module via said predetermined interface. When it comes time to use another type of network standard, a different modular wireless processing module supporting this another type of network standard is inserted into the slots of the predetermined interface of the circuit board.

The wireless processing module may include but not limited to the following network standards: GSM, CDMA2000 1X, WCDMA, WCDMA HSPA, CDMA1X EVDO, TD-SCDMA, WiMax and LTE.

The predetermined interface may include but not limited to the following interfaces: Mini PCI E, USB, Board-board interface, SDIO, PCI, CF, hub, standard or non-standard interface, wire or wireless interface and so on.

The mobile phone may include but not limited to those based on ARM structure, those based on X86 structures or those based on other kind of structure.

The wireless processing module may include but not limited to modules in which the SIM card is integrated with the phone, or modules in which the SIM card is separate from the phone.

Also provided is another mobile phone device capable of changing different network standards. The device includes a mobile phone body circuit board and a modular wireless processing module with different network standards. The mobile phone body circuit board is provided with slots of predetermined interface, while the modular wireless processing module with different network standards is provided with pins of the determined interface. When a specific network standard is employed, the pins of the modular wireless processing module supporting the specific network standard are inserted into corresponding slots of the mobile phone body circuit board. Communication is realized between the circuit board and modular wireless processing module via said predetermined interface. When it comes time to use another type of network standard, a different modular wireless processing module supporting this another type of network standard is inserted into the slots of the predetermined interface of the circuit board.

The wireless processing module may include but not limited to the following network standards: GSM, CDMA2000 1X, WCDMA, WCDMA HSPA, CDMA1X EVDO, TD-SCDMA, WiMax and LTE.

The predetermined interface may include but not limited to the following interfaces: Mini PCI E, USB, Board-board interface, SDIO, PCI, CF, hub, standard or non-standard interface, wire or wireless interface and so on.

The mobile phone may include but not limited to those based on ARM structure, those based on X86 structures or those based on other kind of structure.

The wireless processing module may include but not limited to modules in which the SIM card is integrated with the phone, or modules in which the SIM card is separate from the phone.

Also provided is a method of realizing change of different network standard for a mobile phone. The method includes the steps of:

Modularizing a wireless processing portion with different network standards of the mobile phone to form a wireless processing module with different network standards;

Defining slots of predetermined interface in a mobile phone body circuit board of the phone, and providing pins of the predetermined interface for the wireless processing module with different network standards; and

Inserting the pins of the modular wireless processing module supporting the specific network standard into corresponding slots of the mobile phone body circuit board when using a specific network standard; realizing communication between the circuit board and modular wireless processing module via said predetermined interface; inserting a different modular wireless processing module supporting another type of network standard into the slots of the predetermined interface of the circuit board when changing into another type of network standard.

The modular wireless processing module is assembled together with an SIM card of the mobile phone.

The wireless processing module may include but not limited to the following network standards: GSM, CDMA2000 1X, WCDMA, WCDMA HSPA, CDMA1X EVDO, TD-SCDMA, WiMax and LTE. In addition, the wireless processing module may include but not limited to modules in which the SIM card is integrated with the phone, or modules in which the SIM card is separate from the phone.

Moreover, The predetermined interface may include but not limited to the following interfaces: Mini PCI E, USB, Board-board interface, SDIO, PCI, CF, hub, standard or non-standard interface, wire or wireless interface and so on.

Compared with prior art technology, the present invention bears the following good advantages.

In the present invention, a wireless terminal device capable of changing different network standards is provided. It includes a mobile phone body circuit board and a modular wireless processing module with different network standards. The modular wireless processing module is assembled together with an SIM card of the mobile phone. The mobile phone body circuit board is provided with slots of predetermined interface, while the modular wireless processing module with different network standards is provided with pins of the determined interface. When a specific network standard is employed, the pins of the modular wireless processing module supporting the specific network standard are inserted into corresponding slots of the mobile phone body circuit board. Communication is realized between the circuit board and modular wireless processing module via said predetermined interface. When it comes time to use another type of network standard, a different modular wireless processing module supporting this another type of network standard is inserted into the slots of the predetermined interface of the circuit board. By changing wireless processing module with different network standards, compatibility with 2G networks, 3G networks and even 4G LTE networks in future is realized easily. This makes a mobile phone work with ease under different network standards of the world. In this case, replacement of the mobile phone is unnecessary. What needs to be changed is only wireless processing module with different network standards, thus realizing shifting of the network system. According to an example, the price for a mobile phone supporting 3.5G HSPDA system or EVDO system is RMB 3000, whereas a wireless module supporting the same system is only for RMB 300, which approximately is only one tenth of the mobile phone price. In other words, by using the technology provided by the invention, fees for replacing a mobile phone supporting a desired network system is effectively decreased. The mobile phone made according to the invention can support almost all kinds of network standards all over the world, and can roam freely into different network standards of the world. Important information stored in one mobile phone such as phone book, short message, task management, schedule management and so on will not be lost even in case of replacement of different wireless module. In other words, important information stored in one mobile phone such as phone book, short message, task management, schedule management and so on can still be used when replacing different wireless module. This resolves some problems existing in prior art such as difficulty in transferring information stored in an old mobile phone to a new mobile phone, and necessity of manually copying the information stored in the old phone to the new one due to incompatibility of the two phones. This is especially useful when the amount of information to be transferred is large.

Additionally, the invention changes the manner in which the mobile phone is developed, thus greatly reducing research cost and fabrication cost. Theoretically, the mobile phone of the invention can support any number of network standards including 3G, 4G, 5G and 6G, etc. The mobile phone of the invention can support various kinds of network standards by replacing wireless module of different network standards. It may also be compatible with updated network standards of current standards. Alternatively, in some designs, one wireless module may support multiple network standards, and the user may freely change the wireless module. In addition, the invention also makes it possible for a mobile manufacturer to present mobile phones which can support various kinds of network systems. Therefore, the mobile phone can be marketed at the same time around the world. The research manner of the mobile phone is completely changed thanks to the invention. Research cost of the mobile phone is reduced. By fabrication of a great number of modularized mobile phone bodies and modularized wireless modules, the fabrication cost of the phone body and wireless module are greatly decreased. This makes the mobile phone cheaper and more general in the world.

The preferred embodiments of the present invention will be discussed in detail with reference to the accompanying drawings.

### BRIEF DESCRIPTION OF THE DRAWINGS

FIG. 1 shows schematic block diagram of a prior art mobile phone which only supports one network standard;

FIG. 2 shows a schematic diagram of an embodiment of a mobile phone capable of changing different network standards according to the invention;

FIG. 3 shows a schematic view of an embodiment of a wireless processing module according to the invention; and

FIG. 4 shows a detailed view of an UMPC which is based on X86 structure and has mobile phone function, the principle of the invention being applied to this kind of UMPC.

### DETAILED DESCRIPTION OF THE INVENTION

The invention may be incorporated into any mobile phone including X86 structure-based phone, ARM structure-based phone or other structure-based phone. The mobile phone provided by the invention has the function of changing different network standards. In the invention, wireless processing portion of a mobile phone is separately modularized. That is to say, the wireless processing portion supporting different network standards is correspondingly modularized to many kinds of wireless processing modules support different network standards, thereby separating the mobile phone body from the wireless processing portion. Slots of predetermined interface are defined in the mobile phone body circuit board. For example, semi-opened interface and slots may be defined in the mobile phone body. Kinds of wireless processing modules supporting different network standards are provided with corresponding pins of the predetermined interface. Accordingly, the wireless processing portion can be detached or replaced with ease. In addition, it should be noted that the wireless processing module made according to the invention may include but not limited to modules in which the SIM card is integrated with the phone, or modules in which the SIM card is separate from the phone.

When a specific network standard is employed, the pins of the modular wireless processing module supporting the specific network standard are inserted into corresponding slots of the mobile phone body circuit board, communication being realized between the circuit board and modular wireless processing module via said predetermined interface. When it comes time to use another type of network standard, a different modular wireless processing module supporting this another type of network standard is inserted into the slots of the predetermined interface of the circuit board.

The network standards supported by the wireless processing portion of the invention may include but not limited to GSM/CDMA, GPRS, EDGE, WAN, WCDMA, TD-SCDMA, CDMA EVDO, CDMA EVDV, HSDPA, HSUPA, USPA Plus, and WiMax. The predetermined interface of the semi-opened slots defined in the mobile phone body may include but not limited to Mini PCI E, USB, Board-board interface, SDIO, PCI, CF, hub, standard or non-standard interface. The above interface may be connected with the circuit board of the mobile phone by cable or wireless manner.

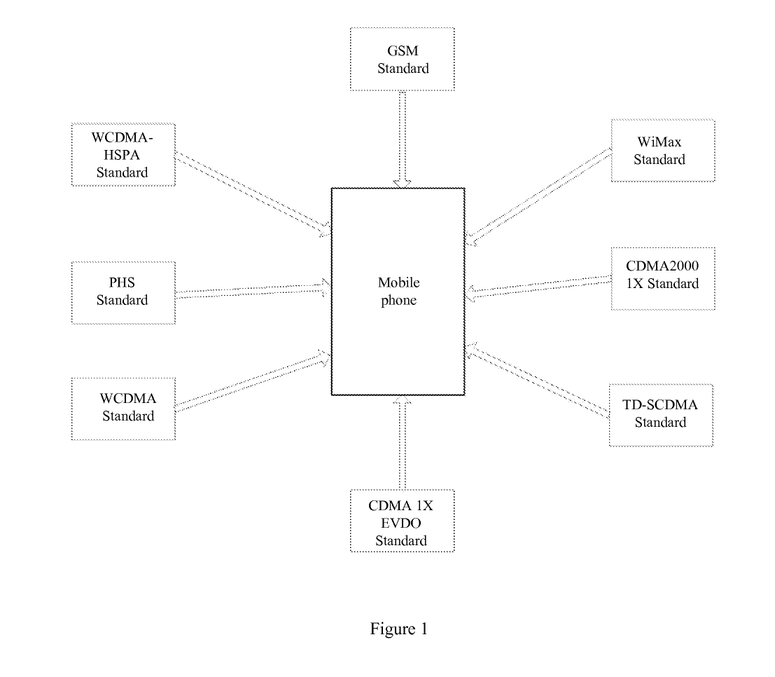

Reference is made to FIG. 1 which shows a schematic block diagram of a prior art mobile phone supporting only one specific network standard. One kind of mobile phone can support only one kind of network standard, and is unable to support any other kind of network such as GSM or CDMA. In prior art, it is almost impossible for a mobile phone to be compatible with all kinds of network standards. Even assuming completely compatible with all kinds of network standards, the size of the mobile phone will become huge. Huge size of the mobile phone is inconsistent with convenience requirement of the mobile phone. Design of the electronic circuit for supporting all kinds of network systems will become difficult. For example, electromagnetic interference problem will become significant when a great number of wireless transmission circuits and receiving circuits are located close to each other. That is to say, design of the circuit becomes complicated. Furthermore, from utility point, incorporation of all kinds of network systems makes no sense since not all of them will be used by a common user.

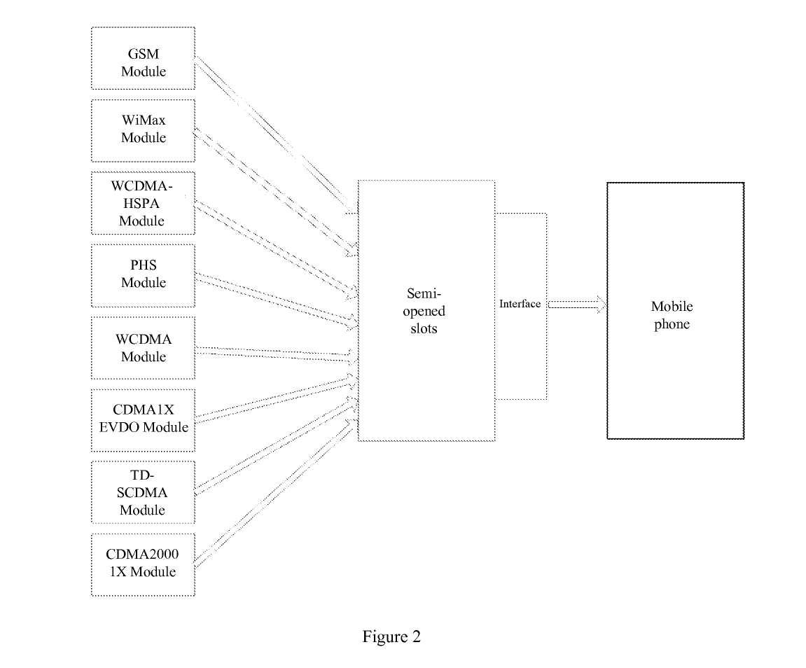

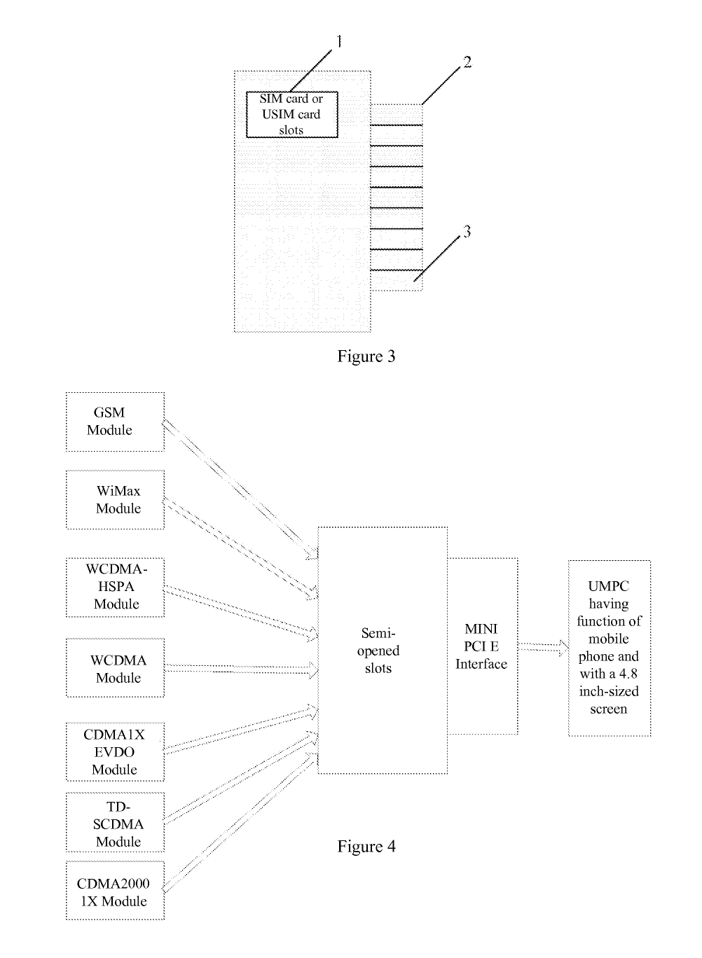

Referring to FIG. 2 which shows a schematic view of a mobile phone capable of changing different network standards. In the present invention, the wireless processing portion of the phone is separated from the circuit board of the phone, thereby forming two components: mobile phone body and extension unit derived from the wireless processing portion of the phone. Interface must be predefined in the circuit board of the phone to connect with the wireless processing module because of separation of the wireless processing portion from the circuit board. The interface may be a standard or non-standard interface. The wireless processing portion is individually modularized and is provided with pins. It is noted that the pins should use the same communication protocol standard as the interface of the circuit board of the mobile phone, and the number of the pins should be consistent with that of the interface. Opened slots are predefined in back portion of the mobile phone body for convenient insertion of modules with different network standards. As shown in FIG. 3 which illustrates a wireless processing module, an SIM slot or USIM slot is defined in the wireless processing module, and pins are provided on the wireless processing module for insertion into the circuit board interface of the opened slot 1 formed on the back portion of the mobile phone body. The number of the pins is consistent with that of the pins of the predetermined interface of the circuit board. Moreover, these pins and interface operate under the same communication protocol rule. When it is desired to roam from 3G WCDMA network (for example in Europe) to CDMA 1X EVDO network (for example in North America), The user can easily remove the wireless module supporting 3G WCDMA network from the semi-opened slot of the back portion of mobile phone, and then insert another wireless module supporting CDMA 1X EVDO network into the slot. At this time, the new wireless module will be identified by the mobile phone and then, the driver software corresponding to the new module will be installed on the mobile phone. Finally, the mobile phone is able to work under CDMA 1X EVDO network. Apparently, the above idea may be applied to a mobile phone to support any network standard all over the world by replacement of desired wireless processing module. This brings convenience for consumers. For example, it is unnecessary for the consumer to replace his own mobile phone when wishing to use another kind of network system, thus reducing fees for replacing network. In addition, replacement of the wireless processing module can be done readily by the consumer without help of professional service man. In other words, the mobile phone made according to the invention is able to support any kinds of network standards around the world.

FIG. 4 shows a detailed view of an UMPC which is based on X86 structure and has mobile phone function, the principle of the invention being applied to this kind of UMPC.

In this example, an UMPC based on X86-structure and with a 4.8 inch touch screen and having mobile phone function is provided. The UMPC operates under Windows XP operating system. Semi-opened slots and Mini PCI E interface are predefined in the back portion of the mobile phone body. A wireless module supporting WCDMA-HSDPA 3G network complying with Europe standard is mounted in the UMPC in advance. For the UMPC to work well under CDMA 1X EVDO 3G network as operated by China Telecom company, previously mounted wireless module supporting WCDMA-HSDPA 3G network should be removed from the semi-opened slots of the back portion of the mobile phone body, and in turn, a new module supporting CDMA 1X EVDO 3G network should be inserted into the slots of the Mini PCI E interface. After that, the phone is powered on and the UMPC begins to run the operating system. The operating system will find the newly installed hardware and automatically install the driver software stored in the module supporting CDMA 1X EVDO 3G network. Finally, the new module will work successfully under CDMA 1X EVDO 3G network. By the same token, to operate under other network, the mobile phone should be provided with suitable wireless module support that specific network. By this way, the mobile phone can work under any kind of network in the world.

1. A mobile phone device capable of changing different network standards, comprising a mobile phone body circuit board and a modular wireless processing module with different network standards, wherein:
the modular wireless processing module is assembled together with an SIM (Subscriber Identity Module) card of the mobile phone;
the mobile phone body circuit board is provided with slots of predetermined interface, while the modular wireless processing module with different network standards is provided with pins of the determined interface;
when a specific network standard is employed, the pins of the modular wireless processing module supporting the specific network standard are inserted into corresponding slots of the mobile phone body circuit board, communication being realized between the circuit board and modular wireless processing module via said predetermined interface; and
when it comes time to use another type of network standard, a different modular wireless processing module supporting this another type of network standard is inserted into the slots of the predetermined interface of the circuit board.

2. The device according to claim 1, wherein the wireless processing module includes but not limited to the following network standards: GSM (Global System for Mobile Communications), CDMA2000 1X (Code-Division Multiple Access 2000 1X), WCDMA (Wideband Code-Division Multiple Access), WCDMA HSPA (Wideband Code-Division Multiple Access High-Speed Packet Access), CDMA1X EVDO (Code-Division Multiple Access 2000 1X Evolution Data Optimization), TD-SCDMA (Time Division-Synchronous Code Division Multiple Access), WiMax (Worldwide Interoperability for Microwave Access) and LTE (Long Term Evolution).

3. The device according to claim 1, wherein the predetermined interface includes but not limited to the following interfaces: Mini PCI E (Mini Peripheral Component Interconnect E), USB (Universal Serial BUS), Board-board interface, SDIO (Secure Digital Input and Output Card), PCI (Peripheral Component Interconnect), CF (Compact Flash), hub, standard or non-standard interface, wire or wireless interface.

4. The device according to claim 1, wherein the mobile phone device includes but not limited to mobile phone devices based on ARM (Advanced RISC (Reduced Instruction Set Computer) Machine) structure, mobile phone devices of notebook type based on X86 structures or mobile phone devices based on other kind of structure; and
the wireless processing module includes but not limited to modules in which the SIM card is integrated with the phone, or modules in which the SIM card is separate from the phone.

5. A mobile phone device capable of changing different network standards, comprising a mobile phone body circuit board and a modular wireless processing module with different network standards, wherein:
the mobile phone body circuit board is provided with slots of predetermined interface, while the modular wireless processing module with different network standards is provided with pins of the determined interface;
when a specific network standard is employed, the pins of the modular wireless processing module supporting the specific network standard are inserted into corresponding slots of the mobile phone body circuit board, communication being realized between the circuit board and modular wireless processing module via said predetermined interface; and
when it comes time to use another type of network standard, a different modular wireless processing module supporting this another type of network standard is inserted into the slots of the predetermined interface of the circuit board.

6. The device according to claim 5, wherein the wireless processing module includes but not limited to the following network standards: GSM (Global System for Mobile Communications), CDMA2000 1X (Code-Division Multiple Access 2000 1X), WCDMA (Wideband Code-Division Multiple Access), WCDMA HSPA (Wideband Code-Division Multiple Access High-Speed Packet Access), CDMA1X EVDO (Code-Division Multiple Access 2000 1X Evolution Data Optimization), TD-SCDMA (Time Division-Synchronous Code Division Multiple Access), WiMax (Worldwide Interoperability for Microwave Access) and LTE (Long Term Evolution).

7. The device according to claim 5, wherein the predetermined interface includes but not limited to the following interfaces: Mini PCI E (Mini Peripheral Component Interconnect E), USB (Universal Serial BUS), Board-board interface, SDIO (Secure Digital Input and Output Card), PCI (Peripheral Component Interconnect), CF (Compact Flash), hub, standard or non-standard interface, wire or wireless interface.

8. The device according to claim 5, wherein the mobile phone device includes but not limited to mobile phone devices based on ARM (Advanced RISC (Reduced Instruction Set Computer) Machine) structure, mobile phone devices of notebook type based on X86 structures or mobile phone devices based on other kind of structure; and
the wireless processing module includes but not limited to modules in which an SIM (Subscriber Identity Module) card is integrated with the phone, or modules in which an SIM card is separate from the phone.

9. A method of realizing change of different network standard for a mobile phone, comprising the steps of:
modularizing a wireless processing portion with different network standards of the mobile phone to form a wireless processing module with different network standards;
defining slots of predetermined interface in a mobile phone body circuit board of the phone, and providing pins of the predetermined interface for the wireless processing module with different network standards; and
inserting the pins of the modular wireless processing module supporting the specific network standard into corresponding slots of the mobile phone body circuit board when using a specific network standard; realizing communication between the circuit board and modular wireless processing module via said predetermined interface; inserting a different modular wireless processing module supporting another type of network standard into the slots of the predetermined interface of the circuit board when changing into another type of network standard.

10. The method according to claim 9, wherein the modular wireless processing module with different network standards is assembled together with an SIM (Subscriber Identity Module) card of the mobile phone;
the wireless processing module includes but not limited to the following network standards: GSM (Global System for Mobile Communications), CDMA2000 1X (Code-Division Multiple Access 2000 1X), WCDMA (Wideband Code-Division Multiple Access), WCDMA HSPA (Wideband Code-Division Multiple Access High-Speed Packet Access), CDMA1X EVDO (Code-Division Multiple Access 2000 1X Evolution Data Optimization), TD-SCDMA (Time Division-Synchronous Code Division Multiple Access), WiMax (Worldwide Interoperability for Microwave Access) and LTE (Long Term Evolution); and
the wireless processing module includes but not limited to modules in which the SIM card is integrated with the phone, or modules in which the SIM card is separate from the phone.

11. The device according to claim 2, wherein the predetermined interface includes but not limited to the following interfaces: Mini PCI E (Mini Peripheral Component Interconnect E), USB (Universal Serial BUS), Board-board interface, SDIO (Secure Digital Input and Output Card), PCI (Peripheral Component Interconnect), CF (Compact Flash), hub, standard or non-standard interface, wire or wireless interface.

12. The device according to claim 6, wherein the predetermined interface includes but not limited to the following interfaces: Mini PCI E (Mini Peripheral Component Interconnect E), USB (Universal Serial BUS), Board-board interface, SDIO (Secure Digital Input and Output Card), PCI (Peripheral Component Interconnect), CF (Compact Flash), hub, standard or non-standard interface, wire or wireless interface.
